(19) United States
(12) Patent Application Publication
(10) Pub. No.: US 2006/0261073 A1
(43) Pub. Date: Nov. 23, 2006

(54) Liner for pressure vessels and process for producing same

(75) Inventor: Yasuharu Kanno, Oyama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: SHOWA DENKO K.K., Tokyo (JP)

(21) Appl. No.: 10/566,712

(22) PCT Filed: Aug. 6, 2004
(86) PCT No.: PCT/JP04/11631

§ 371 Date: Jul. 28, 2006

Related U.S. Application Data
(60) Provisional application No. 60/496,672, filed on Aug. 21, 2003.

(30) Foreign Application Priority Data
Aug. 8, 2003 (JP) 2003-290432

(51) Int. Cl. F17C 1/00

(52) U.S. Cl. 220/581

(57) ABSTRACT

A pressure vessel liner includes a tubular trunk and head plates for closing opposite end openings of the trunk. The pressure vessel liner includes a first liner component providing the trunk, and two second liner components joined respectively to opposite ends of the first liner component and providing the two head plates. The first and second liner components have reinforcing walls provided inside peripheral walls, respectively, and correspond to one another in the position of the reinforcing walls. Each adjacent pair of liner components have their reinforcing walls joined in corresponding relation. The liner has an increased pressure resistant strength against longitudinal forces.

### CROSS REFERENCE TO RELATED APPLICATIONS

This application is an application filed under 35 U.S.C. §111(a) claiming the benefit pursuant to 35 U.S.C. §119(e)(1) of the filing date of Provisional Applications No. 60/469,002 and No. 60/496,672 each filed Aug. 21, 2003 pursuant to 35 U.S.C. §111(b).

### TECHNICAL FIELD

The present invention relates to liners for use in pressure vessels for storing hydrogen gas or natural gas serving as a fuel for power generation, or for use in pressure vessels for storing oxygen gas in oxygen gas supply systems, for example, in the automobile industry, housing industry, military industry, aerospace industry, medical industry, etc. and to a process for producing the liner.

The term “aluminum” as used herein and in the appended claims includes aluminum alloys in addition to pure aluminum.

### BACKGROUND ART

In order to control air pollution, efforts have been made in recent years for developing natural gas motor vehicles and fuel cell motor vehicles which produce clean emissions. These motor vehicles have installed therein a pressure vessel containing fuel natural gas or hydrogen gas to a high pressure, and it is desired to fill the vessel with the gas to a further higher pressure for driving over increased distances.

A liner is already known for use in such high-pressure vessels. The known liner comprises a tubular trunk and a pair of head plates for closing opposite end openings of the trunk. The liner comprises a first liner component made of an aluminum extrudate and in the form of a hollow cylindrical body having opposite open ends for providing the trunk, and two second liner components each generally in the form of a bowl, made from aluminum by die casting and welded respectively to opposite ends of the first component for providing the head plates. The first component has joined to the inner surface thereof a plurality of reinforcing walls which are radial in cross section. Each second liner has a reinforcing wall joined to the inner surface thereof and positioned in corresponding relation with the reinforcing walls of the first component (see the publication of JP-A No. 9-42595).

For use as a pressure vessel, the liner has a helical winding reinforcing layer formed by winding reinforcing fibers around the first component longitudinally thereof and partly around the two second components and impregnating the winding with an epoxy resin for fixing, and a hooped reinforcing layer made by winding reinforcing fibers around the first component circumferentially thereof and impregnating the winding with an epoxy resin for fixing.

The pressure vessel liner disclosed in the publication has a satisfactory pressure resistant strength afforded by the function of the reinforcing walls against radial forces. However, if the liner is subjected to a great force longitudinally thereof, stress acts concentrically on the weld joint of the first component and the second component, possibly fracturing the liner at the joint portion. To prevent such a fracture, there is a need to give an increased thickness to the helical winding reinforcing layer of the pressure vessel, which therefore has the problem of being greater in weight.

An object of the present invention is to overcome the above problem and to provide a pressure container liner having an increased pressure resistant strength against longitudinal forces and a process for fabricating the liner.

### DISCLOSURE OF THE INVENTION

To overcome the above problem, the present invention comprises the following modes.

1) A pressure vessel liner comprising a tubular trunk and two head plates for closing respective opposite end openings of the trunk, the liner being made from at least two liner components so shaped as to be obtained by dividing the trunk with respect to the longitudinal direction thereof, by joining the components, each of the liner components being fixedly provided inside thereof with a reinforcing wall, the liner components corresponding to each other in the position of the reinforcing wall, the reinforcing walls of adjacent pair of liner components being joined to each other.

2) A pressure vessel liner described in par. 1) which is made from a first liner component comprising a tubular body having opposite open ends and providing the trunk, and two second liner components joined to respective opposite ends of the first liner component and providing the respective head plates, the first liner component being fixedly provided inside thereof with a reinforcing wall extending longitudinally thereof and dividing the inside thereof into a plurality of spaces having opposite open ends, each of the second liner components being fixedly provided inside thereof with a reinforcing wall corresponding to the reinforcing wall of the first liner component in position and dividing the inside thereof into a plurality of spaces each having one open end, the reinforcing wall of the first liner component being joined to the reinforcing wall of each second liner component.

3) A pressure vessel liner described in par. 1) which is made from a first liner component in the form of a bottomed tubular body open at one end and closed at the other end and providing the trunk and one of the head plates, and a second liner component joined to the open end of the first liner component and providing the other head plate, the first liner component being fixedly provided inside thereof with a reinforcing wall extending longitudinally thereof and dividing the inside thereof into a plurality of spaces each having one open end, the second liner component being fixedly provided inside thereof with a reinforcing wall corresponding to the reinforcing wall of the first liner component in position and dividing the inside thereof into a plurality of spaces each having one open end, the reinforcing wall of the first liner component being joined to the reinforcing wall of the second liner component.

With the pressure vessel liners described in par. 1) to 3), the reinforcing walls may be engaged with each other and thereby joined. In this case, the length of engagement between the reinforcing walls is preferably at least 10% of the width of the reinforcing wall. Further with the pressure vessel liners described in par. 1) to 3), the reinforcing walls may be metallurgically joined or adhered to each other. In this case, the area of the metallurgical joint or adhesive joint between the reinforcing walls is preferably at least 10% of the cross sectional area of the reinforcing wall. Further with the pressure vessel liners described in par. 1) to 3), it is desired that the reinforcing walls be engaged with each other and also metallurgically joined and/or adhered to each other. In this case, it is desirable that the length of engagement between the reinforcing walls be at least 10% of the width of the reinforcing wall, and that the metallurgical joint and/or adhesive joint between the reinforcing walls be at least 10% of the cross sectional area of the reinforcing wall.

4) A pressure vessel liner described in par. 2) or 3) wherein the first liner component comprises a tubular peripheral wall, a first and a second reinforcing wall inwardly extending from the peripheral wall toward a center line and joined to each other on the center line, the first and second reinforcing walls being positioned in a plane, and a third and a fourth reinforcing wall inwardly extending from peripheral wall portions on opposite sides of the first and second reinforcing walls toward the center line and joined to the first and second reinforcing walls on the center line, the second liner component comprising a peripheral wall generally in the form of a bowl, and first to fourth reinforcing walls provided inside the peripheral wall and corresponding respectively to the first to fourth reinforcing walls of the first liner component,

an end of the peripheral wall of one of the first and second liner components being cut away at portions thereof between the first reinforcing wall and the third and fourth reinforcing walls to cause an end portion of one side face of each of the third and fourth reinforcing walls to project outward beyond the peripheral wall, an internally enlarged groove being formed in end faces of the first and second reinforcing walls and in an end face of the peripheral wall and extending in the end faces of the first and second reinforcing walls longitudinally of the end faces, the internally enlarged groove having opposite end openings in an outer surface of the peripheral wall, a furrow being formed in the side face of each of the third and fourth reinforcing walls projecting outward beyond the peripheral wall and in a stepped portion continuous with the projecting side face, the furrow extending widthwise of each of the third and fourth reinforcing walls to thereby provide an engaging portion,

an end of the peripheral wall of the other of the first and second liner components being cut away at portions thereof between the second reinforcing wall and the third and fourth reinforcing walls to cause an end portion of one side face of each of the third and fourth reinforcing walls to project outward beyond the peripheral wall, a fitting portion being provided on ends of the first and second reinforcing walls and on the end of the peripheral wall and being fittable into the internally enlarged groove of said one liner component, a joint portion of the peripheral wall and the first reinforcing wall and joint portions of the third and fourth reinforcing walls and the first and second reinforcing walls being cut away except parts thereof identical in shape with the cross sectional shape of the fitting portion, a furrow being formed in the side face of each of the third and fourth reinforcing walls projecting outward beyond the peripheral wall and in a stepped portion continuous with the projecting side face, the furrow extending widthwise of each of the third and fourth reinforcing walls to thereby provide an engaging portion, the fitting portion of said other liner component being fitted in the internally enlarged groove of said one liner component, the engaging portions of the two liner components being in engagement with each other.

5) A pressure vessel liner described in par. 4) wherein the two liner components are made of aluminum and joined to each other by friction agitation, electron beam welding, laser welding, MIG welding or TIG welding.

6) A pressure vessel liner described in par. 2) or 3) wherein the first liner component comprises a tubular peripheral wall and a plurality of reinforcing walls inwardly extending from the peripheral wall and joined to one another, an internally enlarged groove being formed in an end face of each of the reinforcing walls and in an end face of the peripheral wall and extending longitudinally of the end face of each reinforcing wall, the internally enlarged groove having an end opening in an outer surface of the peripheral wall,

the second liner component comprising a peripheral wall generally in the form of a bowl and a plurality of reinforcing walls provided inside the peripheral wall and corresponding to the respective reinforcing walls of the first liner component, an internally enlarged groove being formed in an end face of each of the reinforcing walls and in an end face of the peripheral wall and extending longitudinally of the end face of each reinforcing wall, the internally enlarged groove having an end opening in an outer surface of the peripheral wall,

the peripheral wall and the reinforcing walls of the first liner component being butted against the peripheral wall and the reinforcing walls of the second liner component respectively end-to-end, a connecting member being fitted in each of the internally enlarged grooves of the first liner component and the internally enlarged groove of the second liner component opposed thereto across the butted end faces thereof.

7) A pressure vessel liner described in par. 6) wherein the two liner components and an outer end portion of the connecting member are made of aluminum, and the two liner components are joined to each other and the two liner components are joined to the outer end portion of the connecting member by friction agitation, electron beam welding, laser welding, MIG welding or TIG welding.

8) A pressure vessel liner described in par. 2) or 3) wherein the first liner component comprises a tubular peripheral wall, two reinforcing walls inwardly extending from the peripheral wall toward a center line and joined to each other on the center line, the two reinforcing walls being positioned in a plane, and at least one reinforcing wall inwardly extending from the peripheral wall and joined to the two reinforcing walls, the second liner component comprising a peripheral wall generally in the form of a bowl, and a plurality of reinforcing walls provided inside the peripheral wall and corresponding respectively to the reinforcing walls of the first liner component,

one of the first and second liner components having an internally enlarged groove formed in end faces of the two reinforcing walls thereof positioned in the same plane and in an end face of the peripheral wall thereof, the internally enlarged groove extending in the end faces of the two reinforcing walls longitudinally of the end faces and having opposite end openings in an outer surface of the peripheral wall, the other of the first and second liner components having a fitting portion provided on ends of the two reinforcing walls thereof positioned in the same plane and on an end of the peripheral wall thereof and fittable into the internally enlarged groove of said one liner component,

the first and second liner components each having an internally enlarged groove formed in an end face of the other reinforcing wall thereof and in the end face of the peripheral wall thereof and extending in the end face of said other reinforcing wall longitudinally of the end face, the internally enlarged groove of said other reinforcing wall having an end opening in the outer surface of the peripheral wall,

the fitting portion of said other liner component being fitted in the internally enlarged groove in the two reinforcing walls of said one liner component positioned in the same plane and in the peripheral wall, the peripheral wall and the reinforcing walls of the first liner component being butted against the peripheral wall and the reinforcing walls of the second liner component respectively end-to-end, a connecting member being fitted in the internally enlarged groove of said other reinforcing wall of the first liner component and of the peripheral wall thereof and in the internally enlarged groove of said other reinforcing wall of the second liner component and of the peripheral wall thereof across the butted end faces of the walls.

9) A pressure vessel liner described in par. 8) wherein the two liner components and an outer end portion of the connecting member are made of aluminum, and friction agitation joining, electron beam welding, laser welding, MIG welding or TIG welding is resorted to for joining the two liner components to each other, and joining the fitting portion and the outer end portion of the connecting member to peripheral wall portions providing outer end portions of inner peripheral surfaces defining the respective internally enlarged grooves from outside.

10) A process for fabricating a pressure vessel liner described in par. 4) comprising:

preparing a first liner component of aluminum comprising a tubular peripheral wall, a first and a second reinforcing wall inwardly extending from the peripheral wall toward a center line and joined to each other on the center line, the first and second reinforcing walls being positioned in a plane, and a third and a fourth reinforcing wall inwardly extending from peripheral wall portions on opposite sides of the first and second reinforcing walls toward the center line and joined to the first and second reinforcing walls on the center line, and a second liner component of aluminum comprising a peripheral wall generally in the form of a bowl, and first to fourth reinforcing walls provided inside the peripheral wall and corresponding respectively to the first to fourth reinforcing walls of the first liner component,

cutting away portions of an end of the peripheral wall of one of the first and second liner components between the first reinforcing wall and the third and fourth reinforcing walls to cause an end portion of one side face of each of the third and fourth reinforcing walls to project outward beyond the peripheral wall, forming an internally enlarged groove in end faces of the first and second reinforcing walls of said one liner component and in an end face of the peripheral wall thereof, the internally enlarged groove extending in the end faces of the first and second reinforcing walls longitudinally of the end faces and having opposite end openings in an outer surface of the peripheral wall, and forming a furrow in the side face of each of the third and fourth reinforcing walls of said one liner component projecting outward beyond the peripheral wall and in a stepped portion continuous with the projecting side face to thereby provide an engaging portion, the furrow extending widthwise of each of the third and fourth reinforcing walls,

cutting away portions of an end of the peripheral wall of the other of the first and second liner components between the second reinforcing wall and the third and fourth reinforcing walls to cause an end portion of one side face of each of the third and fourth reinforcing walls to project outward beyond the peripheral wall, providing a fitting portion on ends of the first and second reinforcing walls of said other liner component and on the end of the peripheral wall thereof, the fitting portion being fittable into the internally enlarged groove of said one liner component, cutting away a joint portion of the peripheral wall of said other liner component and the first reinforcing wall thereof and joint portions of the third and fourth reinforcing walls of said other liner component and the first and second reinforcing walls thereof except parts thereof identical in shape with the cross sectional shape of the fitting portion, and forming a furrow in the side face of each of the third and fourth reinforcing walls of said other liner component projecting outward beyond the peripheral wall thereof and in a stepped portion continuous with the projecting side face to thereby provide an engaging portion, the furrow extending widthwise of the third and fourth reinforcing walls,

fitting the fitting portion of said other liner component into the internally enlarged groove of said one liner component, and engaging the engaging portions of the two liner components with each other to bring the peripheral walls of the two liner components into contact with each other, and

placing from outside a probe of a friction agitation joining tool into a joint between the peripheral wall of the first liner component and the peripheral wall of the second liner component so as to position the probe partly in both the peripheral walls, and thereafter moving the probe relative to the two liner components to move the probe over the entire circumference of the peripheral walls of the two liner components and join the peripheral walls of the two liner components to each other, an inner peripheral surface of said one liner component defining the internally enlarged groove thereof and the fitting portion of said other liner component to each other and the engaging portions of the two liner components to each other by friction agitation.

11) A process for fabricating a pressure vessel liner described in par. 6) comprising:

preparing a first liner component of aluminum comprising a tubular peripheral wall and a plurality of reinforcing walls inwardly extending from the peripheral wall and joined to one another, and a second liner component of aluminum comprising a peripheral wall generally in the form of a bowl and a plurality of reinforcing walls provided inside the peripheral wall and corresponding to the respective reinforcing walls of the first liner component,

forming an internally enlarged groove in an end face of each of the reinforcing walls of each liner component and in an end face of the peripheral wall thereof, the internally enlarged groove extending longitudinally of the end face of each reinforcing wall and having an end opening in an outer surface of the peripheral wall thereof,

preparing connecting members each fittable into both the internally enlarged groove of the first liner component and the internally enlarged groove of the second liner component and having an aluminum outer portion,

butting the peripheral wall and the reinforcing walls of the first liner component against the peripheral wall and the reinforcing walls of the second liner component respectively end-to-end, and fitting the connecting members respectively into the internally enlarged grooves of the first liner component and the internally enlarged grooves of the second liner component across the butted end faces thereof, and

placing from outside a probe of a friction agitation joining tool into a joint between the peripheral wall of the first liner component and the peripheral wall of the second liner component so as to position the probe partly in both the peripheral walls, and thereafter moving the probe relative to the two liner components to move the probe over the entire circumference of the peripheral walls of the two liner components and join the peripheral walls of the two liner components to each other, and the two liner components to the connecting members by friction agitation.

12) A process for fabricating a pressure vessel liner described in par. 8) comprising:

preparing a first liner component of aluminum comprising a tubular peripheral wall, two reinforcing walls inwardly extending from the peripheral wall toward a center line and joined to each other on the center line, the two reinforcing walls being positioned in a plane, and at least one reinforcing wall inwardly extending from the peripheral wall and joined to the two reinforcing walls, and a second liner component of aluminum comprising a peripheral wall generally in the form of a bowl, and a plurality of reinforcing walls provided inside the peripheral wall and corresponding respectively to the reinforcing walls of the first liner component,

forming an internally enlarged groove in end faces of the two reinforcing walls of one of the first and second liner components which walls are positioned in the same plane and in an end face of the peripheral wall thereof, the internally enlarged groove extending in the end faces of the two reinforcing walls longitudinally of the end faces and having opposite end openings in an outer surface of the peripheral wall, and providing a fitting portion on ends of the two reinforcing walls of the other of the first and second liner components which walls are positioned in the same plane and on an end of the peripheral wall thereof, the fitting portion being fittable into the internally enlarged groove of said one liner component,

forming an internally enlarged groove in an end face of the other reinforcing wall of each of the first and second liner components and in the end face of the peripheral wall thereof, the internally enlarged groove extending in the end face of said other reinforcing wall longitudinally of the end face and having an end opening in the outer surface of the peripheral wall,

preparing a connecting member at least having an outer end portion of aluminum and fittable into both the internally enlarged groove in said other reinforcing wall of the first liner component and the internally enlarged groove in said other reinforcing wall of the second liner component,

fitting the fitting portion on the two reinforcing walls of said other liner component positioned in the same plane and on the peripheral wall into the internally enlarged groove in the two reinforcing walls of said one liner component positioned in the same plane and in the peripheral wall, butting the peripheral wall and the reinforcing walls of the first liner component against the peripheral wall and the reinforcing walls of the second liner component respectively end-to-end, and fitting the connecting member into both the internally enlarged groove of said other reinforcing wall of the first liner component and of the peripheral wall thereof and the internally enlarged groove of said other reinforcing wall of the second liner component and of the peripheral wall thereof across the butted end faces of the walls, and

placing from outside a probe of a friction agitation joining tool into a joint between the peripheral wall of the first liner component and the peripheral wall of the second liner component so as to position the probe partly in both the peripheral walls, and thereafter moving the probe relative to the two liner components to move the probe over the entire circumference of the peripheral walls of the two liner components and join the peripheral walls of the two liner components to each other, and the two liner components to the connecting member by friction agitation.

13) A pressure vessel comprising a pressure vessel liner described in par. 1), 2) or 3) which is covered with a fiber reinforced resin layer over an outer peripheral surface thereof.

14) A fuel cell system comprising a fuel hydrogen pressure vessel, a fuel cell and pressure piping for delivering fuel hydrogen gas from the pressure vessel to the fuel cell therethrough, the fuel hydrogen pressure vessel comprising a pressure vessel described in par. 13).

15) A fuel cell motor vehicle having installed therein a fuel cell system described in par. 14).

16) Cogeneration system comprising a fuel cell system described in par. 14).

17) A natural gas supply system comprising a natural gas pressure vessel and pressure piping for delivering natural gas from the pressure vessel therethrough, the natural gas pressure vessel being a pressure vessel described in par. 13).

18) A cogeneration system comprising a natural gas supply system described in par. 17), a generator and a generator drive device.

19) A natural gas motor vehicle comprising a natural gas supply system described in par. 17) and an engine for use with natural gas as a fuel.

20) An oxygen gas supply system comprising an oxygen pressure vessel and pressure piping for delivering oxygen gas from the pressure vessel therethrough, the oxygen pressure vessel being a pressure vessel described in par. 13).

Since the reinforcing walls of adjacent liner components of the pressure vessel liners described in par. 1) to 3) are joined to each other, the concentration of stress on the joint of the adjacent components is precluded even if the liner is subjected to a great longitudinal force, consequently preventing the joint from fracturing and giving the liner an enhanced pressure resistant strength against longitudinal forces. Accordingly, when the liner is used to provide a pressure vessel, the above feature serves to reduce the thickness of the helical winding reinforcing layer or to eliminate this reinforcing layer, giving reduced weight to the pressure vessel. Moreover, the above feature leads to improved productivity and a reduced cost.

With the pressure vessel liner described in par. 4), the first liner component and the second liner component are joined by fitting the fitting portion into the internally enlarged groove and bringing the engaging portions into engagement with each other. This gives the liner a reliably enhanced pressure resistant strength against longitudinal forces.

The pressure vessel liner described in par. 6) has a connecting member which is fitted into both the internally enlarged grooves of the first and second liner components to join the components, consequently giving a reliably enhanced pressure resistant strength against longitudinal forces.

With the pressure vessel liner described in par. 8), the first and second liner components are joined by fitting the fitting portion into the internally enlarged groove and fitting the connecting member into both the internally enlarged grooves of these components, whereby the liner is given a reliably enhanced pressure resistant strength against longitudinal forces.

The pressure vessel liner described in par. 4) can be fabricated relatively easily by the process described in par. 10).

The pressure vessel liner described in par. 6) can be fabricated relatively easily by the process described in par. 11).

The pressure vessel liner described in par. 8) can be fabricated relatively easily by the process described in par. 12).

### BRIEF DESCRIPTION OF THE DRAWINGS

FIG. 1 is a perspective view of a pressure vessel liner of Embodiment 1 of the invention. FIG. 2 is a view in longitudinal section of a high-pressure vessel comprising the liner of FIG. 1. FIG. 3 is a perspective view showing a process for fabricating the pressure vessel liner of FIG. 1. FIG. 4 is an enlarged fragmentary view in section showing the process for fabricating the pressure vessel liner of FIG. 1. FIG. 5 is a fragmentary perspective view of a process for fabricating a pressure vessel liner of Embodiment 2 of the invention to show a first liner component and a second liner component before they are fitted to each other. FIG. 6 is a fragmentary perspective view showing the first and second liner components as fitted to each other. FIG. 7 is an enlarged view in section taken along the line A-A in FIG. 6. FIG. 8 is an enlarged view in section taken along the line B-B in FIG. 6. FIG. 9 is a fragmentary perspective view of a process for fabricating a pressure vessel liner of Embodiment 3 of the invention to show a first liner component and a second liner component before they are fitted to each other. FIG. 10 is a fragmentary perspective view showing the first and second liner components as fitted to each other. FIG. 11 is an enlarged view in section taken along the line C-C in FIG. 10. FIG. 12 is a fragmentary perspective view of a process for fabricating a pressure vessel liner of Embodiment 4 of the invention to show a first liner component and a second liner component before they are fitted to each other.

### BEST MODE OF CARRYING OUT THE INVENTION

Embodiments of the invention will be described below with reference to the drawings. Throughout all the drawings, like parts are designated by like reference numerals and will not be described repeatedly.

### EMBODIMENT 1

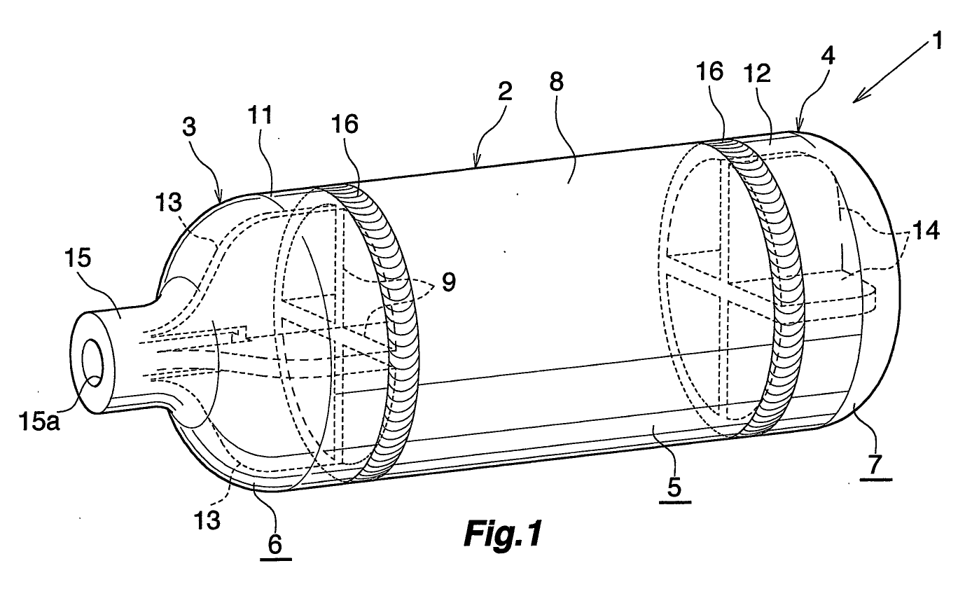

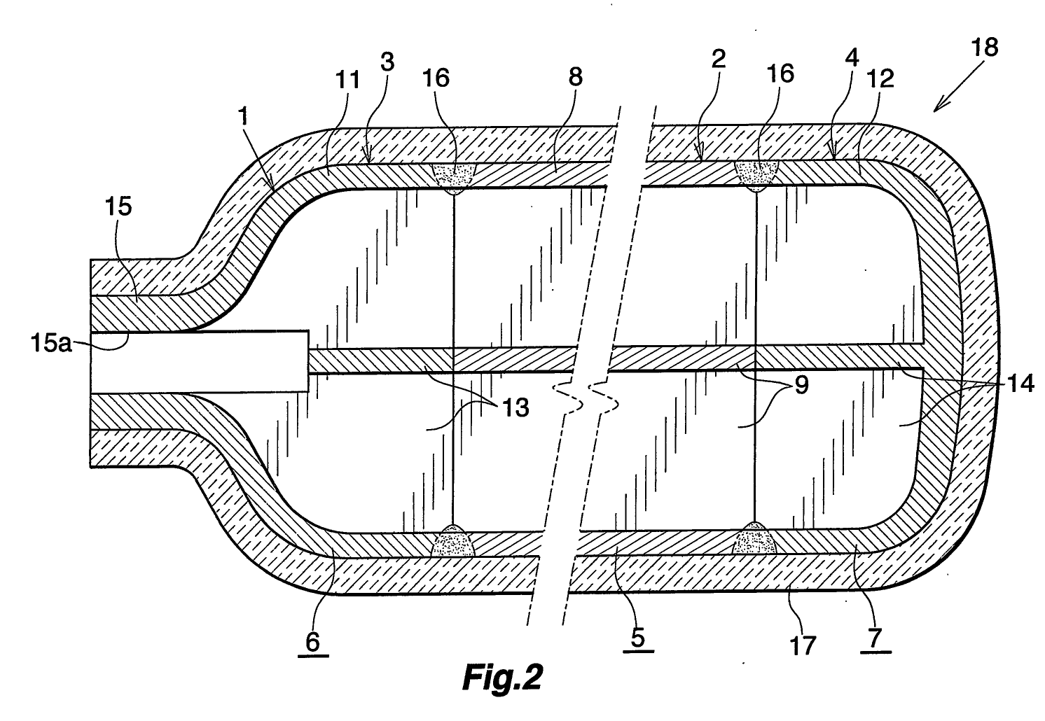

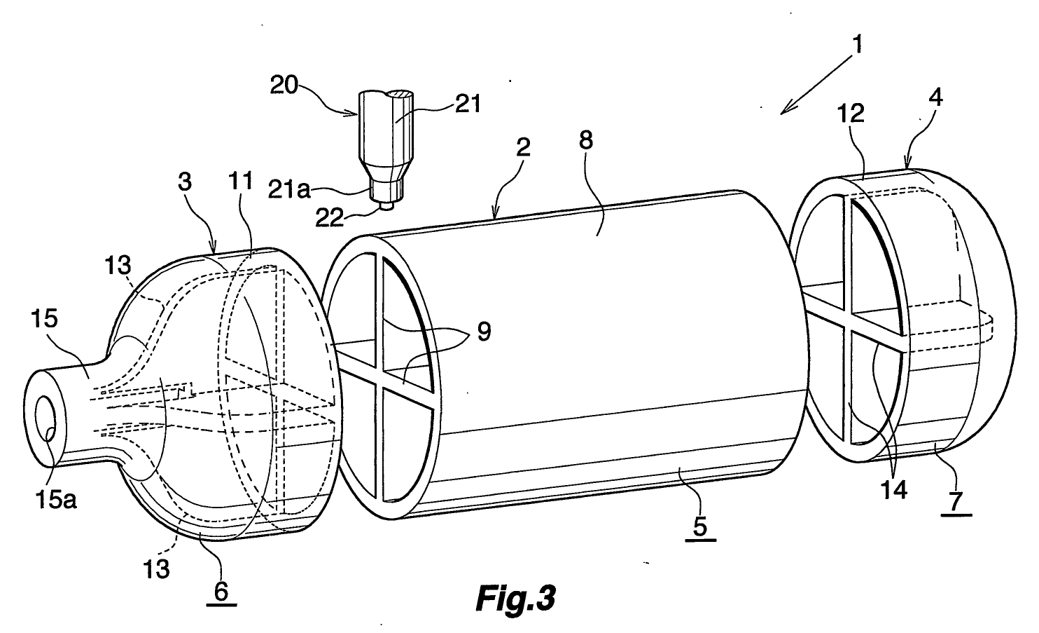

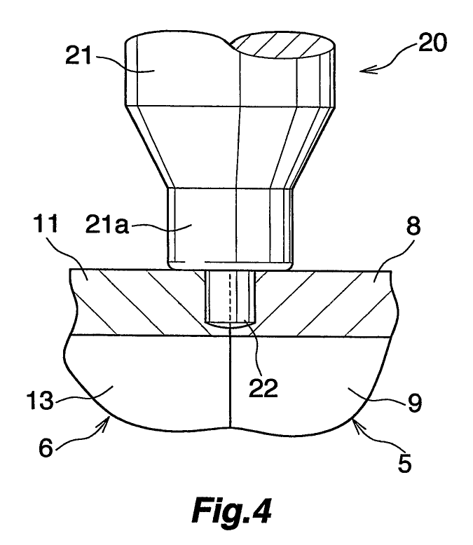

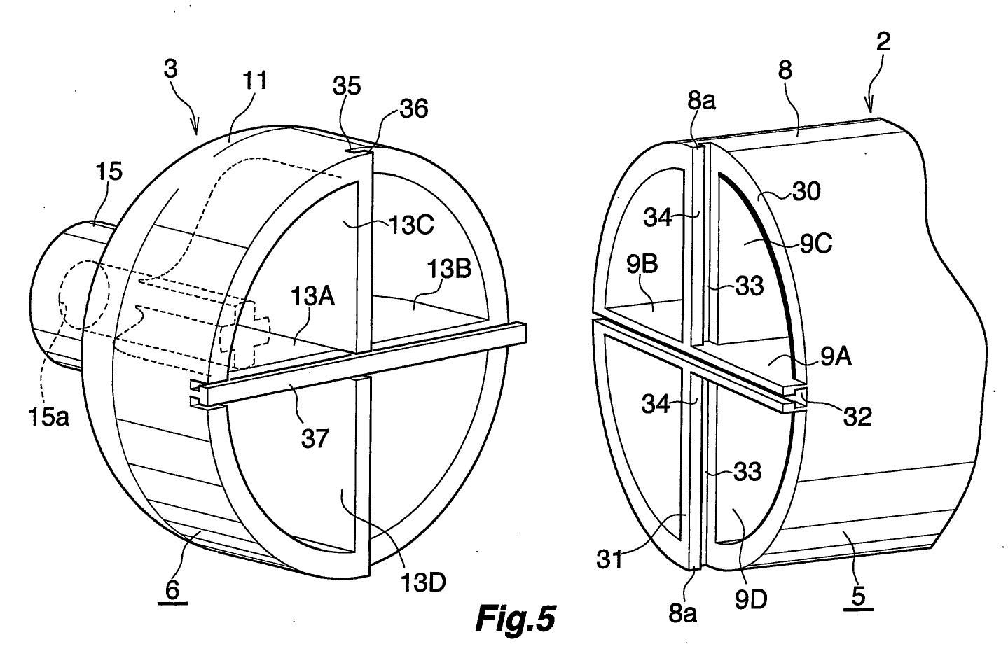

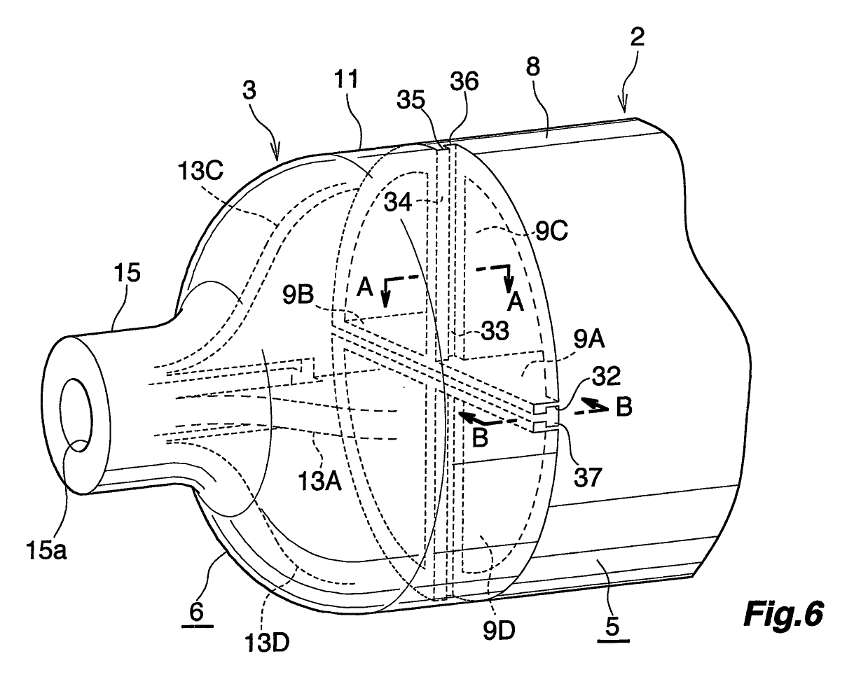

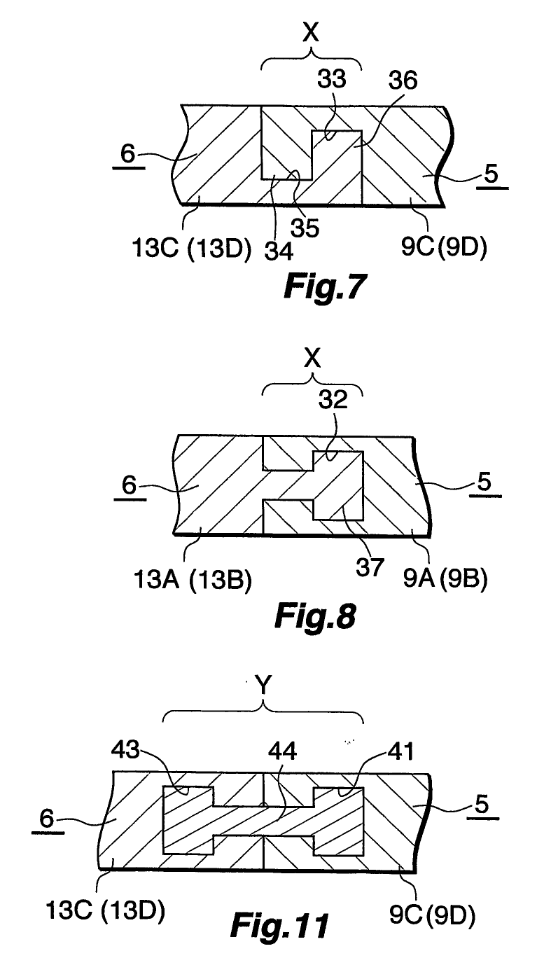

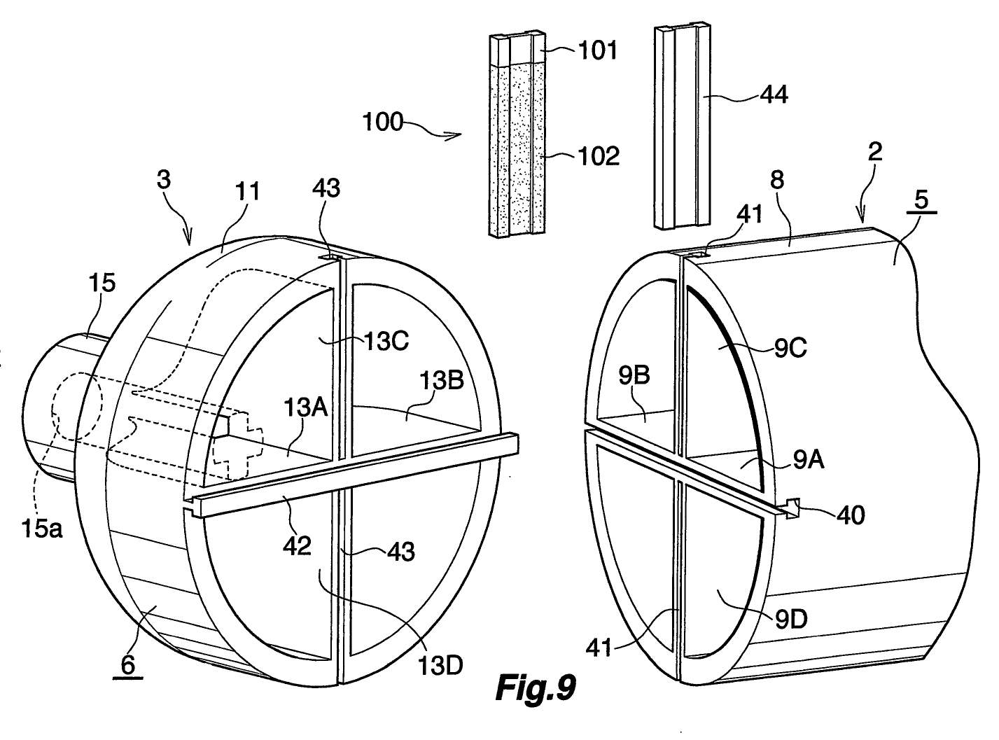

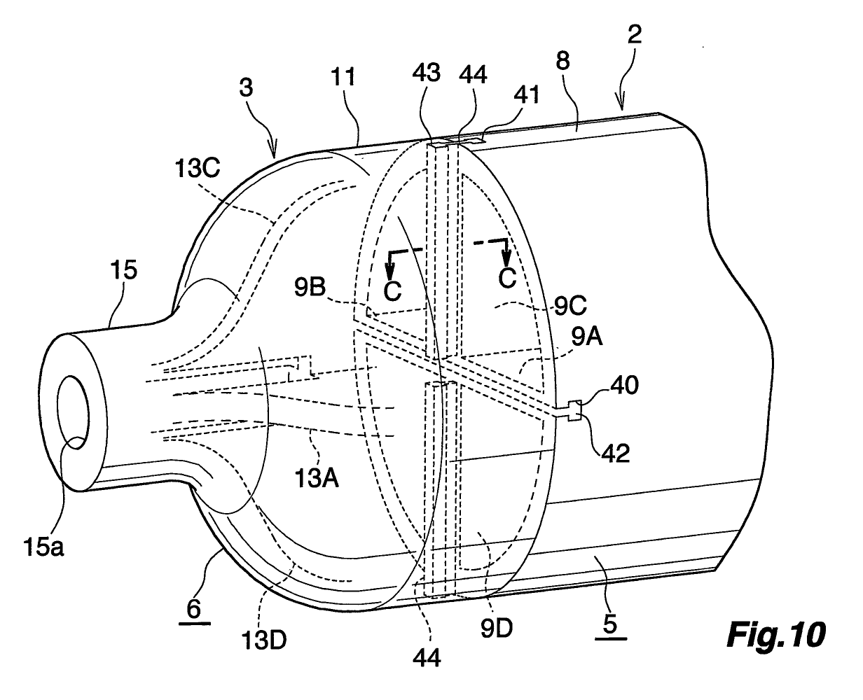

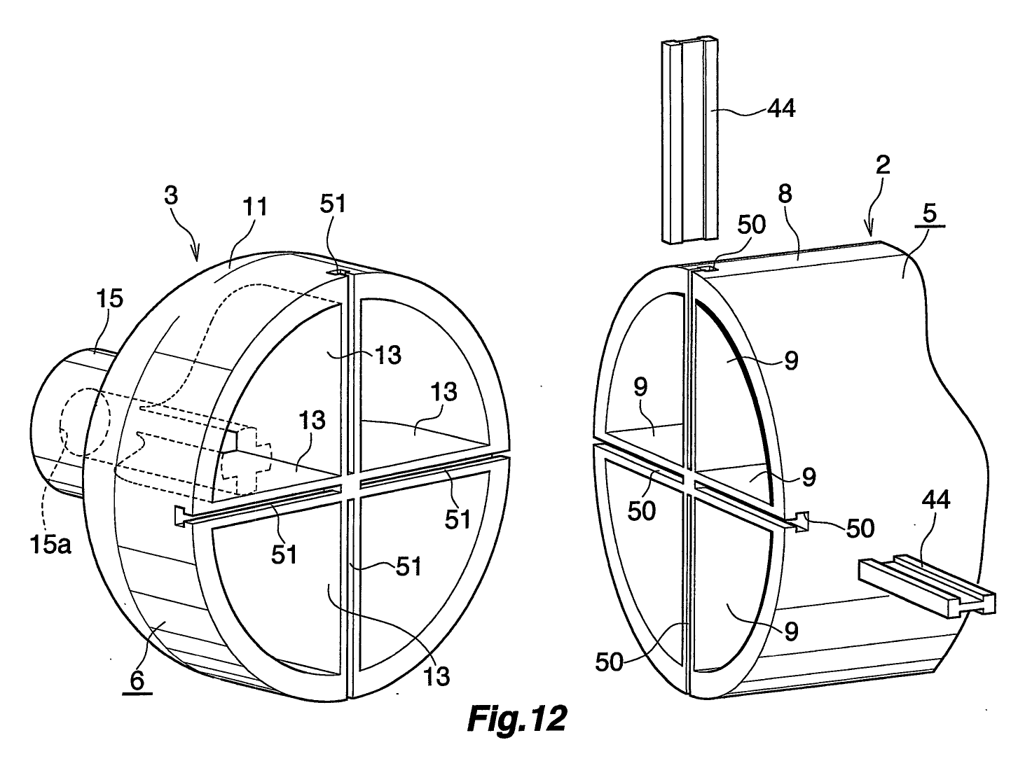

This embodiment is shown in FIGS. 1 to 4.

FIG. 1 shows a pressure vessel liner of this embodiment, FIG. 2 is shows a pressure vessel wherein the liner is used for containing high-pressure hydrogen gas, and FIGS. 3 and 4 show a process for fabricating the pressure vessel liner.

FIG. 1 shows a pressure vessel liner 1, which comprises a trunk 2 and head plates 3, 4 for closing opposite end openings of the trunk 2. The liner 1 comprises a first liner component 5 in the form of an aluminum tube (tubular body) extruded through a porthole die and having opposite open ends for providing the truck 2, and two second liner components 6, 7 of aluminum joined respectively to opposite ends of the first component 5 for providing the head plates 3, 4. The second components 6, 7 are each made by forging or cutting.

The first component 5 comprises a peripheral wall 8 in the form of a hollow cylinder, and a plurality of, i.e., four, reinforcing walls 9 formed over the entire length of the peripheral wall 8 integrally therewith. All the reinforcing walls 9 extend from the inner peripheral surface of the wall 8 inward toward the center line thereof and are joined to one another on the center line. All the reinforcing walls 9 are spaced by equal angles about the center line of the peripheral wall 8. According to Embodiment 1, however, the equal angular spacings between respective adjacent pairs of reinforcing walls 9 about the center line are not limitative. The interior of the peripheral wall 8 is divided by the reinforcing walls 9 into spaces having opposite end openings and equal in number to the number of walls 9.

Each of the second components 6, 7 comprises a peripheral wall 11 (12) generally in the form of a bowl, and a plurality of, i.e., four, reinforcing walls 13 (14) provided inside the peripheral walls 11 (12) integrally therewith and corresponding to the reinforcing walls 9 of the first component 5. The interior of the peripheral wall 11 (12) is divided by the reinforcing walls 13 (14) into spaces each opened at one end thereof and closed at the other end and equal in number to the number of reinforcing walls 13 (14). One of the second components, 6, has a mouthpiece mount portion 15 integral therewith. The mount portion 15 has a bore 15a extending therethrough from the outer end thereof. The ends of the reinforcing walls 13 adjacent to the mount portion 15 are removed simultaneously when the through bore 15a is formed, whereby the interior of the liner 1 is held in communication with the outside.

The first component 5 and the second components 6, 7 are each made, for example, from any one of JIS A2000 alloy, JIS A5000 alloy, JIS A6000 alloy and JIS A7000 alloy. These components may be made from the same material, or at least two of these three components may be made from different materials.

The peripheral wall 8 of the first component 5 has its opposite ends butted against the ends of the peripheral walls 11, 12 of the respective second components 6, 7 and joined thereto by friction agitation. The joints have beads indicated at 16.

The reinforcing walls 9 of the first component 5 are connected respectively to the corresponding reinforcing walls 13, 14 of the second components 6, 7 by being metallurgically joined or adhered thereto. This prevents stress concentration on the joint between the peripheral wall 8 of the liner component 5 and the peripheral wall 11 or 12 of the liner component 6 or 7 even if the assembly is subjected to a great force longitudinally thereof, consequently precluding the joint from fracturing and giving the joint an increased pressure resistant strength against longitudinal forces. The area of the metallurgical joint or adhesive joint between the reinforcing wall 9 and the reinforcing wall 13 or 14 is preferably at least 10% of the combined cross sectional area of the wall 9 or 13 of one of the first component 5 and the second component 6, and the wall 9 or 14 of one of the first component 5 and the other second component 7. If this area is less than 10%, an insufficient pressure resistant strength is likely to result against longitudinal forces.

The metallurgical joint between the reinforcing walls 9 and 13 or 14 is formed, for example, by forge welding, resistance welding or brazing, while a suitable adhesive is used for the adhesion.

As shown in FIG. 2, the liner 1 is entirely enclosed with a fiber reinforced resin layer 17, for example, of carbon fiber reinforced resin for use as a high-pressure vessel 18. As in the pressure vessel liner disclosed in the above publication, the fiber reinforced resin layer 17 comprises a helical winding reinforcing layer formed by winding reinforcing fibers around the first component 5 longitudinally thereof and partly around the two second components 6, 7 and impregnating the winding with an epoxy resin for fixing, and a hooped reinforcing layer made by winding reinforcing fibers around the first component 5 circumferentially thereof and impregnating the winding with an epoxy resin for fixing. The hoped reinforcing layer is not always necessary.

The pressure vessel liner 1 is fabricated by the process to be described below with reference to FIGS. 3 and 4.

First, a first liner component 5 is extruded by an extruder (not shown) having a porthole die. Two second liner components 6, 7 are made by forging or cutting. A bore 15a extending through the mouthpiece mount portion 15 from the outer end thereof is formed in this portion of the second component 6, and the ends of the reinforcing walls 13 adjacent to the mouthpiece mount portion 15 are cut away.

Subsequently, the second components 6, 7 are butted against respective opposite ends of the first component 5, with the peripheral walls 11, 12 in contact with the peripheral wall 8 and the reinforcing walls 13, 14 with the reinforcing walls 9, and the opposed reinforcing walls 13, 14, 9 are metallurgically joined by a suitable method or adhered with use of an adhesive.

One end of the peripheral wall 8 of the first component 5 and the end of the peripheral wall 11 of one of the second components, 6, are then joined by friction agitation using a friction agitation joining tool 20.

The friction agitation joining tool 20 comprises a solid cylindrical rotor 21 having a small-diameter portion 21a provided integrally therewith at a forward end thereof and extending from the rotor axially thereof with a tapered portion provided therebetween, and a pinlike probe 22 extending from the end of the rotor small-diameter portion 21a axially thereof and integrally therewith and having a smaller diameter than the portion 21a (see FIGS. 3 and 4). The rotor 21 and the probe 22 are made of a material harder than the liner components 5, 6, 7 and having heat resistance to withstand the frictional heat to be produced during joining.

Subsequently, while being rotated, the friction agitation joining tool 20 has its probe 22 placed from outside into the butted joint of the peripheral walls 8, 11 of the first component 5 and the second component 6 at a position along the circumferential direction, with the shoulder of the small-diameter portion 21a of the tool 20 around the probe 22 pressed against the peripheral walls 8, 11 (see FIG. 4). At this time, the forward end of the probe 22 is positioned preferably at a distance of at least 0.1 mm to not greater than ½ of the wall thickness of the peripheral walls 8, 11, from the inner peripheral surfaces of the walls 8, 11. If this distance is less than 0.1 mm, it is likely that a V-shaped groove will be formed in the inner peripheral surfaces of the walls 8, 11 circumferentially thereof during the frictional agitation by the probe 22 to be described later, failing to give satisfactory pressure resistance. Alternatively if the distance is in excess of ½ of the wall thickness of the peripheral walls 8, 11, the portions to be joined of the walls 8, 11 become smaller in thickness than the entire thickness of these walls to similarly entail the likelihood that sufficient pressure resistance will not be available. Although the material of a softened portion is likely to scatter at the start of and during the agitation, the shoulder of the small-diameter portion 21a in pressing contact with the outer peripheral walls 8, 11 produces a satisfactory joint by preventing such trouble, further generating frictional heat by the sliding movement of the shoulder on the walls 8, 11 and softening the portions of the walls 8, 11 in contact with the probe 22 and the vicinity thereof to a greater extent while preventing formation of flashes or like irregularities on the surface of the joint.

The friction agitation joining tool 20 is then moved relative to the first and second liner components 5, 6 to move the probe 22 along the butted joint circumferentially thereof. The frictional heat generated by the rotation of the probe 22 and the frictional heat generated by the sliding movement of the shoulder on the peripheral walls 8, 11 soften the base material metal of the walls 8, 11 in the vicinity of the butted joint, and the softened portion is agitated and mixed by being subjected to the rotational force of the probe 22, further plastically flows to fill up a groove left by the passage of the probe 22 and thereafter rapidly loses the frictional heat to solidify on cooling. These phenomena are repeated with the movement of the probe 22 to join the peripheral walls 8, 11 to each other. Upon the return of the probe 22 to the initial position after moving along the butted joint over the entire circumference, the two peripheral walls 8, 11 are joined over the entire circumference. Beads 16 are formed at this time.

After the probe 22 is returned to the initial position where it is placed into the butted joint or after the probe 22 is moved past this position, the probe 22 is moved to the location of a contact member (not shown) disposed at the butted joint of the walls 8, 11, where the probe 22 is withdrawn. In the same manner as above, the other second liner component 7 is also joined to the first liner component 5 by friction agitation. In this way, the pressure vessel linger 1 is fabricated.

According to Embodiment 1, the pressure vessel liner comprises a first liner component 5 and two second liner components 6, 7, whereas these components are not limitative; one of the head plates may be made integral with the trunk. The first component to be used then comprises a bottomed tubular body having an open end and a closed end and providing a trunk and one head plate. In this case, a second liner component providing the other head plate is joined to the open end of the first component. In the case where the second component to be used has no mouthpiece mount portion, the head plate of the first component has a mouthpiece mount portion integral therewith. The first component in the form of a bottomed tubular body is made, for example, by forcing. Further alternatively, the first component may comprise a plurality of divided liner components to be arranged longitudinally thereof.

### EMBODIMENT 2

This embodiment is shown in FIGS. 5 to 8.

In the case of this embodiment, the first liner component 5 has four reinforcing walls. More specifically, it is required that the first component 5 have first and second reinforcing walls 9A, 9B which are positioned in a plane, and third and fourth reinforcing walls 9C, 9D extending respectively from upper and lower portions of the peripheral wall 8 on opposite sides of the first and second reinforcing walls 9A, 9B toward the center line of the wall 8 and joined to the two reinforcing walls 9A, 9B on the center line as shown in FIG. 5. The third and fourth reinforcing walls 9C, 9D are at right angles with the first and second reinforcing walls 9A, 9B, and all the reinforcing walls 9A to 9D are spaced by equal angles about the center line of the peripheral wall 8. However, the third and fourth reinforcing walls 9C, 9D need not always be at right angles with the first and second reinforcing walls 9A, 9B.

The second liner component 6 has first to fourth reinforcing walls 13A, 13B, 13C, 13D corresponding respectively to the first to fourth reinforcing walls 9A to 9D of the first liner component 5. State more specifically, the first and second reinforcing walls 13A, 13B are positioned in a plane, and the third and fourth reinforcing walls 13C, 13D extend respectively from upper and lower portions of the peripheral wall 11 on opposite sides of the first and second reinforcing walls 13A, 13B toward the center line of the wall 11 and joined to the two reinforcing walls 13A, 13B on the center line. Although not shown, the other second liner component 7 has exactly the same construction as the second liner component 6 except that the other component has no mouthpiece mount portion and no through bore, so that the second component 6 only will be described herein.

Each of opposite ends of the peripheral wall 8 of the first component 5 is cut away over a predetermined length at the portions thereof between the first reinforcing wall 9A and the third and fourth reinforcing walls 9C, 9D, whereby the corresponding ends of the third and fourth reinforcing walls 9C, 9D are caused to project at the cut-away portions 30 beyond the peripheral wall 8. The projecting portions are indicated at 31. A stepped portion 8a is formed in the peripheral wall 8 between each cut-away portion 30 and the other portion thereof. An internally enlarged groove 32 generally T-shaped in cross section is formed in the end faces of the first and second reinforcing walls 9A, 9B and also in the end of the peripheral wall 8. The groove 32 extends in the end faces of the walls 9A, 9B longitudinally of the end faces and has opposite end openings in the outer surface of the peripheral wall 8. A groove 33 is formed in each of the projecting portions 31 of the third and fourth reinforcing walls 9C, 9C and also in the stepped portion 8a to extend widthwise of the wall 9C or 9D (i.e., along the length of each of the third and fourth reinforcing walls 9C, 9C as seen in cross section). The projecting portion 31 has an engaging portion 34 integral therewith and positioned outwardly of the groove 33.

The end of the peripheral wall 11 of the second liner component 6 is cut away over a predetermined length at the portions thereof between the second reinforcing wall 13B and the third and fourth reinforcing walls 13C, 13D, whereby the corresponding ends of the third and fourth reinforcing walls 13C, 13D are caused to project at the cut-away portions beyond the peripheral wall 11 as is the case with the first component 5 to provide grooves 35 and engaging portions 36. The ends of the first and second reinforcing walls 13A, 13B and the end of the peripheral wall 36 are integrally provided with a fitting portion 37 fittable into the internally enlarged groove 32 of the first component 5. The joint portion of the peripheral wall 11 of the second component 6 and the first reinforcing wall 13A and the joint portions of the third and fourth reinforcing walls 13C, 13D and the first and second reinforcing walls 13A, 13B are cut away except portions thereof identical in shape with the cross sectional shape of the fitting portion 37.

The sum of the thickness of the bottom wall of each groove 33 of the first component 5 and the thickness of the outer end of each engaging portion 36 (outer side wall defining the groove) of the second component 6, and the sum of the thickness of the bottom wall of each groove 35 of the second component 6 and the thickness of the outer end of each engaging portion 34 (outer side wall defining the groove) of the first component 5 are equal to the thickness of the third and fourth reinforcing walls 9C, 9D and the thickness of the third and fourth reinforcing walls 13C, 13D, respectively.

The fitting portion 37 of the second component 6 is fitted into the internally enlarged groove 32 of the first component 5, and the engaging portions 34 of the first component 5 are engaged with the engaging portions 36 of the second component 6, with the engaging portions 34 of the first component 5 fitted into the grooves 35 of the second component 6, and with the engaging portions 36 of the second component 6 fitted into the grooves 33 of the first component 5 (see FIGS. 6 to 8).

The end of the peripheral wall 8 of the first component 5 is butted against and joined to the end of the peripheral wall 11 of the second component 6 over the entire circumference by friction agitation.

The fitting portion 37 of the second component 6 may be metallurgically joined to, or adhered to the inner peripheral surface of the first component 5 defining the internally enlarged groove 32. The metallurgical joining is effected as by forge welding, resistance welding or brazing. Adhesion is effected using a suitable adhesive. In this case, the length of the fitting portion 37 joined or adhered to the groove (32) defining inner peripheral surface is preferably at least 10% of the sum of the widths of the first and second reinforcing walls 9A, 9B or 13A, 13B of one of the components 5 and 6. If the length is less than 10%, an insufficient pressure resistant strength will result against longitudinal forces.

Alternatively, the fitting portion 37 of the second component 6 may be forced into the internally enlarged groove 32 of the first component by shrinkage fit. Further alternatively, the fitting portion 37 may be placed into the groove 32 by freeze fit.

The engaging portions 34, 36 of the two liner components 5, 6 may be metallurgically joined or adhered to each other. For metallurgical joining, for example, forge welding, resistance welding or brazing is resorted to. Adhesion is done using a suitable adhesive. In this case, the lengths of the engaging portions 34, 36 joined or adhered to each other are preferably at least 10% of the combined width of the third and fourth reinforcing walls 9C, 9D or 13C, 13D of one of the liner components 5, 6. If the lengths are less than 10%, an insufficient pressure resistant strength will result against longitudinal forces.

The pressure vessel liner of Embodiment 2 is fabricated by the process to be described below.

First, a first liner component 5 and two second liner components 6, are made in the same manner as in Embodiment 1. In the second component 6 having a mouthpiece mount portion 15, a through bore 15a is formed in the portion 15 from the outer end of this portion, and the ends of the reinforcing walls 13A to 13D adjacent to the mount portion 15 are cut away.

An internally enlarged groove 32, grooves 33 and engaging portions 34 are then formed at each of opposite ends of the first component 5. Grooves 35, engaging portions 36 and a fitting portion 37 are formed at the inner end of each second component 6.

Subsequently, the fitting portion 37 of the second component 6 is fitted into the internally enlarged groove 32 of the first component 5, and the engaging portions 34, 36 of the two components 5, 6 are engaged with each other to butt the peripheral walls 8, 11 of the two components 5, 6 against each other (see FIG. 6). When required, the fitting portion 37 of the second component 6 is metallurgically joined or adhered to the inner peripheral surface of the first component 5 defining the internally enlarged groove 32. Alternatively, the fitting portion 37 of the second component 6 is placed into the internally enlarged groove 32 of the first component 5 by shrinkage fit or freeze fit. Further the engaging portions 34, 36 of the two components 5, 6 are metallurgically joined or adhered to each other.

The end of the peripheral wall 8 of the first component 5 is then joined to the end of the peripheral wall 11 of the second component 6 by friction agitation in the same manner as in Embodiment 1 described. At this time, the procedure for moving the probe 22 along the butted joint of the peripheral walls 8, 11 of the two liner components 5, 6 over the entire circumference is performed while shifting the probe 22 from the contact joint between the outer end of the engaging portion 34 of the first component 5 and the base-end side face of the second component 6 defining the groove 35 to the contact joint between the outer end of the engaging portion 36 of the second component and the base-end side face of the first component 5 defining the groove 33, and also from the contact joint between the bottom face of the internally enlarged groove 32 of the first component 5 and the fitting portion 37 of the second component 6 to the contact joint between the end faces of the first and second reinforcing walls 9A, 9B of the first component 5 and the end face of the second component 6 provided with the fitting portion 37, i.e., while shifting the probe 22 repeatedly several times longitudinally of the peripheral walls 8, 11 over the ranges X indicated in FIGS. 7 and 8 from one end of each range to the other end thereof. This makes it possible to join the end of the peripheral wall 8 of the first component 5 to the end of the peripheral wall 11 of the second component 6 by friction agitation, to join the opposite ends of the groove (32) defining inner peripheral surface of the first component to the respective opposite ends of the fitting portion 37 of the second component 6, and to join the engaging portions 34, 36 of the two components 5, 6 to each other at their outer opposite ends, by friction agitation.

In the same manner as above, the other second liner component 6 is joined to the first liner component 5 by friction agitation. In this way, a pressure vessel liner is fabricated.

### EMBODIMENT 3

This embodiment is shown in FIGS. 9 to 11.

In the case of this embodiment, it is required that two of a plurality of reinforcing walls, i.e., first and second reinforcing walls 9A, 9B, of the first liner component 5 be positioned in a plane as shown in FIG. 9. The number of other reinforcing walls, i.e., third and fourth reinforcing walls 9C, 9C, and the angles the third and fourth reinforcing walls 9C, 9D make with the first and second reinforcing walls 9A, 9B are suitably variable.

The second liner component 6 has first to fourth reinforcing walls 13A, 13B, 13C, 13D so arranged as to correspond respectively to the first to fourth reinforcing walls 9A to 9D of the first liner component 5. Stated more specifically, the first and second reinforcing walls 13A, 13B are positioned in a plane, and the third and fourth reinforcing walls 13C, 13D inwardly extend from upper and lower portions of the peripheral wall 11 on opposite sides of the first and second reinforcing walls 13A, 13B toward the center line of the wall 11 and are joined to the two walls 13A, 13B on the center line. Although not shown, the other second liner component has exactly the same construction as the above second liner component 6 except that the other second component has no mouthpiece mount portion and no through bore, and one second component 6 only will be described herein.

An internally enlarged groove 40 generally T-shaped in cross section is formed in the end faces of the first and second reinforcing walls 9A, 9B of the first liner component 5 which are positioned in the same plane and also in the end face of the peripheral wall 8. The groove 40 extends in the end faces of the walls 9A, 9B longitudinally of the end faces and has opposite end openings in the outer surface of the peripheral wall 8. Further an internally enlarged groove 41 generally T-shaped in cross section is formed in each of the end faces of the third and fourth reinforcing walls 9C, 9D of the first component 5 and also in the end face of the peripheral wall 8. The groove 41 extends in the end face of each of the walls 9C, 9D longitudinally of the end face from the outer surface of the peripheral wall 8 approximately to the position of the center line and has one end opening in the outer surface of the peripheral wall 8.

A fitting portion 42 generally T-shaped in cross section and fittable into the internally enlarged groove 40 of the first component 5 is integrally formed on the ends of the first and second reinforcing walls 13A, 13B of the second liner component 6 and also on the end of the peripheral wall 11. The fitting portion 42 extends on the ends of the walls 13A, 13B longitudinally of the wall ends and has opposite ends at the outer surface of the peripheral wall 11. Further an internally enlarged groove 43 generally T-shaped in cross section is formed in each of the end faces of the third and fourth reinforcing walls 13C, 13D of the second component 6 and also in the end face of the peripheral wall 11. The groove 43 extends in the end face of each of the walls 13C, 13D longitudinally of the end face from the outer surface of the peripheral wall 11 approximately to the position of the center line and has one end opening in the outer surface of the peripheral wall 11.

The fitting portion 42 of the second component 6 is fitted in the internally enlarged groove 40 of the first component 5, the end faces of the peripheral walls 8, 11 of the two components 5, 6 are butted against each other, the end faces of the reinforcing walls 9A to 9D of the first component 5 are butted against the end faces of the corresponding walls 13A to 13D of the second component 6, and an aluminum connecting member 44H-shaped in cross section is fitted in each internally enlarged groove 41 of the first component 5 and also in the corresponding groove 43 of the second component 6 across the butted joint of the walls concerned in intimate contact with the two components (see FIGS. 10 and 11).

The butted joint between the end of the peripheral wall 8 of the first component 5 and the end of the peripheral wall 11 of the second component 6 is joined by friction agitation. The outer end portion of each connecting member 44 is joined to the two liner components 5, 6 by friction agitation.

The fitting portion 42 of the second component 6 may be metallurgically joined or adhered to the inner peripheral surface of the first component 5 defining the internally enlarged groove 40. The connecting member may be metallurgically joined or adhered to the inner peripheral surfaces of the two liner components 5, 6 defining the internally enlarged grooves 41, 43. The metallurgical joining is effected as by forge welding, resistance welding or brazing, while the adhesion is done using a suitable adhesive. In this case, the metallurgical joint or adhesive joint of the fitting portion 42 and the inner peripheral surface defining the groove 41, and like joint between the connecting member 44 and the inner peripheral surfaces defining the grooves 41, 43 have a length which is preferably at least 10% of the combined width of the first and second reinforcing walls 9A, 9B or 13A, 13B of one of the liner components 5, 6. If the length is less than 10%, an insufficient pressure resistant strength will result against longitudinal forces.

Further alternatively, the fitting portion 42 and the connecting member 44 may be placed into the groove 40 or grooves 41, 43 by shrinkage fit or freeze fit.

The pressure vessel liner is fabricated by the process to be described below.

First, a first liner component 5 and two second liner components 6, are made in the same manner as in Embodiment 1. In the second component 6 having a mouthpiece mount portion 15, a through bore 15a is formed in the portion 15 from the outer end of this portion, and the ends of the reinforcing walls 13A to 13D adjacent to the mount portion 15 are cut away.

An internally enlarged groove 40 is then formed in the end faces of the first and second reinforcing walls 9A, 9B of the first component 5 and in the end face of the peripheral wall 8, and an internally enlarged groove 41 is formed in the end face of each of the third and fourth reinforcing walls 9C, 9D and in the end face of the peripheral wall. A fitting portion 42 is provided on the ends of the first and second reinforcing walls 13A, 13B of each second component 6 and on the end of the peripheral wall 11, and an internally enlarged groove 43 is formed in the end face of each of the third and fourth reinforcing walls 13C, 13D and in the end face of the peripheral wall 11.

The fitting portion 42 of the second component 6 is fitted into the groove 40 of the first component 5, the end faces of the peripheral walls 8, 11 of the first and second components 5, 6 are butted against each other, and the end faces of the reinforcing walls 9A to 9D are butted against the end faces of the corresponding walls 13A to 13D, and connecting members 44 are thereafter fitted into the respective opposed pairs of internally enlarged grooves 41 in the first component 5 and grooves 43 in the second component 6 in intimate contact with these components. When required, the fitting portion 42 and the connecting member 44 are metallurgically joined or adhered to the inner peripheral surface defining the groove 40 or to those defining the grooves 41, 43. Further alternatively, the fitting portion 42 and the connecting member 44 may be placed into the groove 40 or grooves 41, 43 by shrinkage fit or freeze fit.

Subsequently, in the same manner as in the case of Embodiment 1 described, the end of the peripheral wall 8 of the first component 5 is joined to the end of the peripheral wall 11 of the second component 6 by friction agitation. At this time, the procedure for moving the probe 22 along the butted joint of the peripheral walls 8, 11 of the two liner components 5, 6 over the entire circumference is performed while shifting the probe 22 from the contact joint between the bottom face of the internally enlarged groove 40 in the first component 5 and the fitting portion 42 and the contact joint between the bottom face of the groove 41 in the first component 5 and the connecting member 44 to the contact joint between the bottom face of the groove 43 in the second component 6 and the connecting member 44, i.e., while shifting the probe 22 repeatedly several times longitudinally of the peripheral walls 8, 11 over the range Y indicated in FIG. 11 from one end of this range to the other end thereof. This makes it possible to join the end of the peripheral wall 8 of the first component 5 to the end of the peripheral wall 11 of the second component 6 by friction agitation as described above and to join the fitting portion 42 and the connecting member 44 to the inner peripheral surface defining the groove 40 or to the inner peripheral surfaces defining the grooves 41, 43 by friction agitation.

The other second liner component is also joined to the first liner component 5 by friction agitation in the same manner as above. In this way, a pressure vessel liner is fabricated.

According to Embodiment 3, the connecting member 44 is made of aluminum in its entirety, whereas this structure is not limitative; an outer end portion only may be made of aluminum as indicated at 100 in FIG. 9. Stated more specifically, at least two components 101, 102 provide a connecting member 100, and the component 101 at the outer end is made of aluminum. The other component is then made from stainless steel, other iron alloy, copper (including a copper alloy) or like metal, or a resin.

Further according to Embodiment 3, the first and second components 5, 6 have reinforcing walls other than the first and second reinforcing walls 9A, 9B or 13A, 13B, i.e., the third and fourth reinforcing walls 9C, 9D or 13C, 13D, which are joined to the first and second reinforcing walls 9A, 9B or 13A, 13B on the center line of the trunk 2, whereas such arrangement of reinforcing walls is not limitative; these walls may be joined to the first and second reinforcing walls 9A, 9B or 13A, 13B at a location or portion other than the center line.

### EMBODIMENT 4

This embodiment is shown in FIG. 12.

In the case of this embodiment, the number of reinforcing walls 9 provided in the first liner component 5 as shown in FIG. 12 and the spacing between these walls 9 about the center line of the peripheral wall 8 are variable suitably. The second liner component 6 has reinforcing walls 13 corresponding to the reinforcing walls 9 of the first component 5 in position and number. Although not shown, the other second liner component has exactly the same construction as the above second liner component 6 except that the other second component has no mouthpiece mount portion and no through bore, and one second component 6 only will be described herein.

The first component 5 has an internally enlarged groove 50 generally T-shaped in cross section and formed in the end face of each of the reinforcing walls 9 and in the end face of the peripheral wall 8. The groove 50 extends longitudinally of the end face of the wall 9 from the outer surface of the peripheral wall 8 approximately to the location of the center line and has an end opening in the outer surface of the peripheral wall 8.

The second component 6 has an internally enlarged groove 51 generally T-shaped in cross section and formed in the end face of each of the reinforcing walls 13 and in the end face of the peripheral wall 11. The groove 51 extends longitudinally of the end face of the wall 13 from the outer surface of the peripheral wall 11 approximately to the location of the center line of the peripheral wall 11 and has an end opening in the outer surface of the peripheral wall 11.

A connecting member 44 is fitted in each internally enlarged groove 50 of the first component 5 and the corresponding internally enlarged groove 51 of the second component 6 in intimate contact with these components 5, 6.

The end of the peripheral wall 8 of the first component 5 is butted against the end of the peripheral wall 11 of the second liner component 6, and the butted joint is joined by friction agitation over the entire circumference. The connecting member 44 has an outer end portion joined to the two liner components 5, 6 by friction agitation.

The connecting member 44 may be metallurgically joined or adhered to the inner peripheral surfaces of the first and second components 5, 6 defining the respective internally enlarged grooves 50, 51. The metallurgical joining is effected as by forge welding, resistance welding or brazing, while the adhesion is done using a suitable adhesive. In this case, the metallurgical or adhesive joint between the connecting member 44 and the inner peripheral surfaces defining the grooves 50, 51 has a length which is preferably at least 10% of the width of the grooved reinforcing wall 9 or 13 of one of the liner components 5, 6. If the length is less than 10%, an insufficient pressure resistant strength will result against longitudinal forces.

Further alternatively, the connecting member 44 may be placed into the grooves 50, 51 of the first and second components 5, 6 by shrinkage fit or freeze fit.

The pressure vessel liner is fabricated by the process to be described below.

First, a first liner component 5 and two second liner components 6, are made in the same manner as in Embodiment 1. In the second component 6 having a mouthpiece mount portion 15, a through bore 15a is formed in the portion 15 from the outer end of this portion, and the ends of the reinforcing walls 13 adjacent to the mount portion 15 are cut away.

Internally enlarged grooves 50 are then formed in the end faces of the respective reinforcing walls 9 of the first liner component 5 and end face of the peripheral wall 8, and internally enlarged grooves 51 in the end faces of the respective reinforcing walls 13 of the second liner component 6 and the end face of the peripheral wall 11 thereof.

The peripheral wall 8 and the reinforcing walls 9 of the first component 5 are subsequently butted respectively against the peripheral wall 11 and the reinforcing walls 13 of the second component 6 end-to-end, and an connecting member 44 is thereafter fitted from outside into each groove 50 in the first component 5 and into the corresponding groove 51 in the second component 6 in intimate contact with these components 5, 6. When required, the connecting member 44 is metallurgically joined or adhered to the inner peripheral surfaces of the components 5, 6 defining the respective grooves 50, 51. Alternatively, the connecting member 44 is placed into the grooves 50, 51 of the liner components 5, 6 by shrinkage fit or freeze fit.

Subsequently, in the same manner as in the case of Embodiment 1 described, the end of the peripheral wall 8 of the first component 5 is joined to the end of the peripheral wall 11 of the second component 6 by friction agitation. At this time, the procedure for moving the probe 22 along the butted joint of the peripheral walls 8, 11 of the two liner components 5, 6 over the entire circumference is performed while shifting the probe 22 from the contact joint between the bottom face of the internally enlarged groove 50 in the first component 5 and the connecting member 44 to the contact joint between the bottom face of the internally enlarged groove 51 in the second component 6 and the connecting member 44, repeatedly several times longitudinally of the peripheral walls 8, 11. This makes it possible to join the end of the peripheral wall 8 of the first component 5 to the end of the peripheral wall 11 of the second component 6 by friction agitation as described above and to join the connecting member 44 to the inner peripheral surfaces defining the grooves 50, 51 by friction agitation.

The other second liner component is also joined to the first liner component 5 by friction agitation in the same manner as above. In this way, a pressure vessel liner 1 is fabricated.

According to Embodiment 4, the connecting member 44 need not be made of aluminum in its entirety as is the case with Embodiment 3. At least two components 101, 102 may provide a connecting member 100, and the component 101 positioned at the outer end is made from aluminum. The other component is then made from stainless steel, other iron alloy, copper (including a copper alloy) or like metal, or a resin.

Further according to Embodiment 4, all the reinforcing walls 9 or 13 of each of the first and second components 5, 6 are joined on the center line, whereas this arrangement is not limitative; the walls may be joined at a suitable location. For example, two reinforcing walls are joined on the center line, and the other reinforcing walls may be joined to one of the walls at a position away from the center line.

Like the pressure vessel liner of Embodiment 1, the pressure vessel liners of Embodiments 2 to 4 are entirely covered with a fiber reinforced resin layer 17, for example, of carbon fiber reinforced resin for use as high-pressure vessels. As is the case with the pressure vessel liner disclosed in the foregoing publication, the fiber reinforced resin layer comprises a helical winding reinforcing layer formed by winding reinforcing fibers around the first component longitudinally thereof and partly around the two second components and impregnating the winding with an epoxy resin for fixing, and a hooped reinforcing layer made by winding reinforcing fibers around the first component 5 circumferentially thereof and impregnating the winding with an epoxy resin for fixing. The hooped reinforcing layer need not always be provided.

According to Embodiments 3 and 4, the number of reinforcing layers is not limited to four but is suitably variable.

Although the pressure vessel liners of Embodiments 2 to 4 are each made from one first liner component and two second liner components, this construction is not limitative; one of the head plates may be made integral with the trunk. Stated more specifically, the first liner component to be used may comprise a bottom tubular body which is open at one end and closed at the other end and which provides a trunk and one of head plates. One of the second liner components providing the other head plate is joined to the open end of the first liner component. In the case where the second liner component to be used has no mouthpiece mount portion, a mouthpiece mount portion is formed integrally with the head plate of the first liner component. The first component in the form of a bottomed tubular body is made, for example, by forging. Alternatively, the first component may comprise a plurality of divided liner components to be arranged longitudinally of the first component.

In all the foregoing embodiments, the trunk, i.e., the peripheral wall of the first component, is circular in cross section, whereas this structure is not limitative and can be altered suitably. For example, the component may have an elliptical cross section (which is not only one so defined mathematically but which includes such a shape as is obtained by collapsing a circle to a flat form). The peripheral wall of the second component is then altered in shape in conformity with the shape of the first.

In all the foregoing embodiments, the first liner component and the second liner component are joined by friction agitation, whereas the liner so constructed is not limitative; the two components may be joined by some other suitable method, such as fusion welding, electron beam welding, laser welding, MIG welding, TIG welding or like common welding method. In this case, fusion welding, electron beam welding, laser welding, MIG welding, TIG welding or like method is also resorted to for joining the fitting portion to the inner peripheral surface defining an internally enlarged groove and for joining the connecting member to the inner peripheral surfaces defining internally enlarged grooves according to Embodiment 3, and for joining the connecting member to like surfaces defining internally enlarged grooves.

High-pressure vessels comprising a liner 1 according to any one of Embodiments 1 to 4 are used in fuel cell systems which comprise a fuel hydrogen pressure vessel, a fuel cell and pressure piping for delivering fuel hydrogen gas from the pressure vessel to the fuel cell to serve as the fuel hydrogen pressure vessel. The fuel cell system is installed in motor vehicles. The fuel cell system is used also in cogeneration systems.

The high-pressure vessel is used also in natural gas supply systems which comprise a natural gas pressure vessel and pressure piping for delivering natural gas from the pressure vessel to serve as the natural gas pressure vessel. The natural gas supply system is used in cogeneration systems along with a generator and a generator drive device. The natural gas supply system is used also in natural gas motor vehicles equipped with an engine for use with natural gas as the fuel.

The high-pressure vessel is used further in oxygen gas supply systems which comprise an oxygen pressure vessel and pressure piping for delivering oxygen gas from the pressure vessel to serves as the oxygen pressure vessel.

### INDUSTRIAL APPLICABILITY

The present invention provides a pressure vessel liner useful, for example, in the automobile industry, housing industry, military industry, aerospace industry, medical industry, etc. and suitable for use in pressure vessels for storing hydrogen gas or natural gas serving as a fuel for power generation, or for use in pressure vessels for storing oxygen gas. The liner has an enhanced pressure resistant strength against longitudinal forces.

1. A pressure vessel liner comprising a tubular trunk and two head plates for closing respective opposite end openings of the trunk, the liner being made from at least two liner components so shaped as to be obtained by dividing the trunk with respect to the longitudinal direction thereof, by joining the components,
each of the liner components being fixedly provided inside thereof with a reinforcing wall, the liner components corresponding to each other in the position of the reinforcing wall, the reinforcing walls of adjacent pair of liner components being joined to each other.

2. A pressure vessel liner according to claim 1 which is made from a first liner component comprising a tubular body having opposite open ends and providing the trunk, and two second liner components joined to respective opposite ends of the first liner component and providing the respective head plates, the first liner component being fixedly provided inside thereof with a reinforcing wall extending longitudinally thereof and dividing the inside thereof into a plurality of spaces having opposite open ends, each of the second liner components being fixedly provided inside thereof with a reinforcing wall corresponding to the reinforcing wall of the first liner component in position and dividing the inside thereof into a plurality of spaces each having one open end, the reinforcing wall of the first liner component being joined to the reinforcing wall of each second liner component.

3. A pressure vessel liner according to claim 1 which is made from a first liner component in the form of a bottomed tubular body open at one end and closed at the other end and providing the trunk and one of the head plates, and a second liner component joined to the open end of the first liner component and providing the other head plate, the first liner component being fixedly provided inside thereof with a reinforcing wall extending longitudinally thereof and dividing the inside thereof into a plurality of spaces each having one open end, the second liner component being fixedly provided inside thereof with a reinforcing wall corresponding to the reinforcing wall of the first liner component in position and dividing the inside thereof into a plurality of spaces each having one open end, the reinforcing wall of the first liner component being joined to the reinforcing wall of the second liner component.

4. A pressure vessel liner according to claim 2 wherein the first liner component comprises a tubular peripheral wall, a first and a second reinforcing wall inwardly extending from the peripheral wall toward a center line and joined to each other on the center line, the first and second reinforcing walls being positioned in a plane, and a third and a fourth reinforcing wall inwardly extending from peripheral wall portions on opposite sides of the first and second reinforcing walls toward the center line and joined to the first and second reinforcing walls on the center line, the second liner component comprising a peripheral wall generally in the form of a bowl, and first to fourth reinforcing walls provided inside the peripheral wall and corresponding respectively to the first to fourth reinforcing walls of the first liner component,
an end of the peripheral wall of one of the first and second liner components being cut away at portions thereof between the first reinforcing wall and the third and fourth reinforcing walls to cause an end portion of one side face of each of the third and fourth reinforcing walls to project outward beyond the peripheral wall, an internally enlarged groove being formed in end faces of the first and second reinforcing walls and in an end face of the peripheral wall and extending in the end faces of the first and second reinforcing walls longitudinally of the end faces, the internally enlarged groove having opposite end openings in an outer surface of the peripheral wall, a furrow being formed in the side face of each of the third and fourth reinforcing walls projecting outward beyond the peripheral wall and in a stepped portion continuous with the projecting side face, the furrow extending widthwise of each of the third and fourth reinforcing walls to thereby provide an engaging portion,
an end of the peripheral wall of the other of the first and second liner components being cut away at portions thereof between the second reinforcing wall and the third and fourth reinforcing walls to cause an end portion of one side face of each of the third and fourth reinforcing walls to project outward beyond the peripheral wall, a fitting portion being provided on ends of the first and second reinforcing walls and on the end of the peripheral wall and being fittable into the internally enlarged groove of said one liner component, a joint portion of the peripheral wall and the first reinforcing wall and joint portions of the third and fourth reinforcing walls and the first and second reinforcing walls being cut away except parts thereof identical in shape with the cross sectional shape of the fitting portion, a furrow being formed in the side face of each of the third and fourth reinforcing walls projecting outward beyond the peripheral wall and in a stepped portion continuous with the projecting side face, the furrow extending widthwise of each of the third and fourth reinforcing walls to thereby provide an engaging portion,
the fitting portion of said other liner component being fitted in the internally enlarged groove of said one liner component, the engaging portions of the two liner components being in engagement with each other.

5. A pressure vessel liner according to claim 4 wherein the two liner components are made of aluminum and joined to each other by friction agitation, electron beam welding, laser welding, MIG welding or TIG welding.

6. A pressure vessel liner according to claim 2 wherein the first liner component comprises a tubular peripheral wall and a plurality of reinforcing walls inwardly extending from the peripheral wall and joined to one another, an internally enlarged groove being formed in an end face of each of the reinforcing walls and in an end face of the peripheral wall and extending longitudinally of the end face of each reinforcing wall, the internally enlarged groove having an end opening in an outer surface of the peripheral wall,
the second liner component comprising a peripheral wall generally in the form of a bowl and a plurality of reinforcing walls provided inside the peripheral wall and corresponding to the respective reinforcing walls of the first liner component, an internally enlarged groove being formed in an end face of each of the reinforcing walls and in an end face of the peripheral wall and extending longitudinally of the end face of each reinforcing wall, the internally enlarged groove having an end opening in an outer surface of the peripheral wall,
the peripheral wall and the reinforcing walls of the first liner component being butted against the peripheral wall and the reinforcing walls of the second liner component respectively end-to-end, a connecting member being fitted in each of the internally enlarged grooves of the first liner component and the internally enlarged groove of the second liner component opposed thereto across the butted end faces thereof.

7. A pressure vessel liner according to claim 6 wherein the two liner components and an outer end portion of the connecting member are made of aluminum, and the two liner components are joined to each other and the two liner components are joined to the outer end portion of the connecting member by friction agitation, electron beam welding, laser welding, MIG welding or TIG welding.

8. A pressure vessel liner according to claim 2 or 3 wherein the first liner component comprises a tubular peripheral wall, two reinforcing walls inwardly extending from the peripheral wall toward a center line and joined to each other on the center line, the two reinforcing walls being positioned in a plane, and at least one reinforcing wall inwardly extending from the peripheral wall and joined to the two reinforcing walls, the second liner component comprising a peripheral wall generally in the form of a bowl, and a plurality of reinforcing walls provided inside the peripheral wall and corresponding respectively to the reinforcing walls of the first liner component,
one of the first and second liner components having an internally enlarged groove formed in end faces of the two reinforcing walls thereof positioned in the same plane and in an end face of the peripheral wall thereof, the internally enlarged groove extending in the end faces of the two reinforcing walls longitudinally of the end faces and having opposite end openings in an outer surface of the peripheral wall, the other of the first and second liner components having a fitting portion provided on ends of the two reinforcing walls thereof positioned in the same plane and on an end of the peripheral wall thereof and fittable into the internally enlarged groove of said one liner component,
the first and second liner components each having an internally enlarged groove formed in an end face of the other reinforcing wall thereof and in the end face of the peripheral wall thereof and extending in the end face of said other reinforcing wall longitudinally of the end face, the internally enlarged groove of said other reinforcing wall having an end opening in the outer surface of the peripheral wall,
the fitting portion of said other liner component being fitted in the internally enlarged groove in the two reinforcing walls of said one liner component positioned in the same plane and in the peripheral wall, the peripheral wall and the reinforcing walls of the first liner component being butted against the peripheral wall and the reinforcing walls of the second liner component respectively end-to-end, a connecting member being fitted in the internally enlarged groove of said other reinforcing wall of the first liner component and of the peripheral wall thereof and in the internally enlarged groove of said other reinforcing wall of the second liner component and of the peripheral wall thereof across the butted end faces of the walls.

9. A pressure vessel liner according to claim 8 wherein the two liner components and an outer end portion of the connecting member are made of aluminum, and friction agitation joining, electron beam welding, laser welding, MIG welding or TIG welding is resorted to for joining the two liner components to each other, and joining the fitting portion and the outer end portion of the connecting member to peripheral wall portions providing outer end portions of inner peripheral surfaces defining the respective internally enlarged grooves from outside.

10. A process for fabricating a pressure vessel liner according to claim 4 comprising:
preparing a first liner component of aluminum comprising a tubular peripheral wall, a first and a second reinforcing wall inwardly extending from the peripheral wall toward a center line and joined to each other on the center line, the first and second reinforcing walls being positioned in a plane, and a third and a fourth reinforcing wall inwardly extending from peripheral wall portions on opposite sides of the first and second reinforcing walls toward the center line and joined to the first and second reinforcing walls on the center line, and a second liner component of aluminum comprising a peripheral wall generally in the form of a bowl, and first to fourth reinforcing walls provided inside the peripheral wall and corresponding respectively to the first to fourth reinforcing walls of the first liner component,
cutting away portions of an end of the peripheral wall of one of the first and second liner components between the first reinforcing wall and the third and fourth reinforcing walls to cause an end portion of one side face of each of the third and fourth reinforcing walls to project outward beyond the peripheral wall, forming an internally enlarged groove in end faces of the first and second reinforcing walls of said one liner component and in an end face of the peripheral wall thereof, the internally enlarged groove extending in the end faces of the first and second reinforcing walls longitudinally of the end faces and having opposite end openings in an outer surface of the peripheral wall, and forming a furrow in the side face of each of the third and fourth reinforcing walls of said one liner component projecting outward beyond the peripheral wall and in a stepped portion continuous with the projecting side face to thereby provide an engaging portion, the furrow extending widthwise of each of the third and fourth reinforcing walls,
cutting away portions of an end of the peripheral wall of the other of the first and second liner components between the second reinforcing wall and the third and fourth reinforcing walls to cause an end portion of one side face of each of the third and fourth reinforcing walls to project outward beyond the peripheral wall, providing a fitting portion on ends of the first and second reinforcing walls of said other liner component and on the end of the peripheral wall thereof, the fitting portion being fittable into the internally enlarged groove of said one liner component, cutting away a joint portion of the peripheral wall of said other liner component and the first reinforcing wall thereof and joint portions of the third and fourth reinforcing walls of said other liner component and the first and second reinforcing walls thereof except parts thereof identical in shape with the cross sectional shape of the fitting portion, and forming a furrow in the side face of each of the third and fourth reinforcing walls of said other liner component projecting outward beyond the peripheral wall thereof and in a stepped portion continuous with the projecting side face to thereby provide an engaging portion, the furrow extending widthwise of the third and fourth reinforcing walls,
fitting the fitting portion of said other liner component into the internally enlarged groove of said one liner component, and engaging the engaging portions of the two liner components with each other to bring the peripheral walls of the two liner components into contact with each other, and
placing from outside a probe of a friction agitation joining tool into a joint between the peripheral wall of the first liner component and the peripheral wall of the second liner component so as to position the probe partly in both the peripheral walls, and thereafter moving the probe relative to the two liner components to move the probe over the entire circumference of the peripheral walls of the two liner components and join the peripheral walls of the two liner components to each other, an inner peripheral surface of said one liner component defining the internally enlarged groove thereof and the fitting portion of said other liner component to each other and the engaging portions of the two liner components to each other by friction agitation.

11. A process for fabricating a pressure vessel liner according to claim 6 comprising:
preparing a first liner component of aluminum comprising a tubular peripheral wall and a plurality of reinforcing walls inwardly extending from the peripheral wall and joined to one another, and a second liner component of aluminum comprising a peripheral wall generally in the form of a bowl and a plurality of reinforcing walls provided inside the peripheral wall and corresponding to the respective reinforcing walls of the first liner component,
forming an internally enlarged groove in an end face of each of the reinforcing walls of each liner component and in an end face of the peripheral wall thereof, the internally enlarged groove extending longitudinally of the end face of each reinforcing wall and having an end opening in an outer surface of the peripheral wall thereof,
preparing connecting members each fittable into both the internally enlarged groove of the first liner component and the internally enlarged groove of the second liner component and having an aluminum outer portion,
butting the peripheral wall and the reinforcing walls of the first liner component against the peripheral wall and the reinforcing walls of the second liner component respectively end-to-end, and fitting the connecting members respectively into the internally enlarged grooves of the first liner component and the internally enlarged grooves of the second liner component across the butted end faces thereof, and
placing from outside a probe of a friction agitation joining tool into a joint between the peripheral wall of the first liner component and the peripheral wall of the second liner component so as to position the probe partly in both the peripheral walls, and thereafter moving the probe relative to the two liner components to move the probe over the entire circumference of the peripheral walls of the two liner components and join the peripheral walls of the two liner components to each other, and the two liner components to the connecting members by friction agitation.

12. A process for fabricating a pressure vessel liner according to claim 8 comprising:
preparing a first liner component of aluminum comprising a tubular peripheral wall, two reinforcing walls inwardly extending from the peripheral wall toward a center line and joined to each other on the center line, the two reinforcing walls being positioned in a plane, and at least one reinforcing wall inwardly extending from the peripheral wall and joined to the two reinforcing walls, and a second liner component of aluminum comprising a peripheral wall generally in the form of a bowl, and a plurality of reinforcing walls provided inside the peripheral wall and corresponding respectively to the reinforcing walls of the first liner component,
forming an internally enlarged groove in end faces of the two reinforcing walls of one of the first and second liner components which walls are positioned in the same plane and in an end face of the peripheral wall thereof, the internally enlarged groove extending in the end faces of the two reinforcing walls longitudinally of the end faces and having opposite end openings in an outer surface of the peripheral wall, and providing a fitting portion on ends of the two reinforcing walls of the other of the first and second liner components which walls are positioned in the same plane and on an end of the peripheral wall thereof, the fitting portion being fittable into the internally enlarged groove of said one liner component,
forming an internally enlarged groove in an end face of the other reinforcing wall of each of the first and second liner components and in the end face of the peripheral wall thereof, the internally enlarged groove extending in the end face of said other reinforcing wall longitudinally of the end face and having an end opening in the outer surface of the peripheral wall,
preparing a connecting member at least having an outer end portion of aluminum and fittable into both the internally enlarged groove in said other reinforcing wall of the first liner component and the internally enlarged groove in said other reinforcing wall of the second liner component,
fitting the fitting portion on the two reinforcing walls of said other liner component positioned in the same plane and on the peripheral wall into the internally enlarged groove in the two reinforcing walls of said one liner component positioned in the same plane and in the peripheral wall, butting the peripheral wall and the reinforcing walls of the first liner component against the peripheral wall and the reinforcing walls of the second liner component respectively end-to-end, and fitting the connecting member into both the internally enlarged groove of said other reinforcing wall of the first liner component and of the peripheral wall thereof and the internally enlarged groove of said other reinforcing wall of the second liner component and of the peripheral wall thereof across the butted end faces of the walls, and
placing from outside a probe of a friction agitation joining tool into a joint between the peripheral wall of the first liner component and the peripheral wall of the second liner component so as to position the probe partly in both the peripheral walls, and thereafter moving the probe relative to the two liner components to move the probe over the entire circumference of the peripheral walls of the two liner components and join the peripheral walls of the two liner components to each other, and the two liner components to the connecting member by friction agitation.

13. A pressure vessel comprising a pressure vessel liner according to claim 1, which is covered with a fiber reinforced resin layer over an outer peripheral surface thereof.

14. A fuel cell system comprising a fuel hydrogen pressure vessel, a fuel cell and pressure piping for delivering fuel hydrogen gas from the pressure vessel to the fuel cell therethrough, the fuel hydrogen pressure vessel comprising a pressure vessel according to claim 13.

15. A fuel cell motor vehicle having installed therein a fuel cell system according to claim 14.

16. Cogeneration system comprising a fuel cell system according to claim 14.

17. A natural gas supply system comprising a natural gas pressure vessel and pressure piping for delivering natural gas from the pressure vessel therethrough, the natural gas pressure vessel being a pressure vessel according to claim 13.

18. A cogeneration system comprising a natural gas supply system according to claim 17, a generator and a generator drive device.

19. A natural gas motor vehicle comprising a natural gas supply system according to claim 17 and an engine for use with natural gas as a fuel.

20. An oxygen gas supply system comprising an oxygen pressure vessel and pressure piping for delivering oxygen gas from the pressure vessel therethrough, the oxygen pressure vessel being a pressure vessel according to claim 13.
